(19) United States
(12) Patent Application Publication
(10) Pub. No.: US 2004/0104070 A1
(43) Pub. Date: Jun. 3, 2004

(54) Speaker's damper with lead wire and guide sleeve

(76) Inventor: Yen-Chen Chan, Hsin Chuang City (TW)

Correspondence Address: SUPREME PATENT SERVICES, POST OFFICE BOX 2339, SARATOGA, CA, 95070, US

(21) Appl. No.: 10/308,413

(22) Filed: Dec. 2, 2002

(51) Int. Cl. H04R 7/00; G10K 13/00

(52) U.S. Cl. 181/166

(57) ABSTRACT

A speaker's damper is comprised of a main body and lead wires, in which the damper's main body is essentially a piece of woven cloth pressed in form of an annular disk with a corrugated cutaway section while the lead wire is a metallic wire in texture properly interwoven in the damper's main body, such that the jumping-rope phenomenon of the lead wire can be avoided when the damper's main body is in vibration. Also, by means of a guide sleeve, two lead wires can be prevented from being short-circuited during vibration of the damper's main body.

### FIELD OF THE INVENTION

The present invention pertains to a speaker's damper, and more specifically to a speaker's damper with lead wire and guide sleeve.

### BACKGROUND OF THE INVENTION

A damper for exclusive application to a generic speaker so far is disposed between the main body and the drum paper of the speaker, in which an external signal is provided to a signal terminal on the main body, then transmitted to the drum paper through a lead wire suspended over the damper. Therefore, because of the speaker's construction like this, the lead wire is liable to be ruptured to incur a signal's interruption when dismounting the speaker or outputting power to cause a jumping-rope phenomenon of the suspended lead wire when vibrating, such that the lead wire is supposed either to be broken or short-circuited.

This inventor is, in view of abovesaid defects, intended to propose the invention as of the captioned subject in hopes of providing an alternative to this field.

### SUMMARY OF THE INVENTION

For improvements, the inventor is to provide a speaker's damper combined with a lead wire, whereby the lead wire cannot be ruptured easily or short-circuited between two wires just because of vibrating or dragging. The damper of this invention is comprised of a main body and lead wires, in which the damper's main body is essentially a piece of woven cloth pressed in form of an annular disk with a corrugated cutaway section while the lead wire is a metallic wire in texture properly interwoven in the damper's main body, such that the jumping-rope phenomenon can be avoided when the damper's main body is in vibration. In addition, by means of a guide sleeve, two lead wires can be prevented from being short-circuited during vibration of the damper's main body.

The merits of the speaker's damper may be summarized as the following by performing this invention:

(1) The broken rate of lead wire can be lowered significantly;

(2) The jumping-rope phenomenon and hence the incurred rupture of lead wire can be avoided; and

(3) The short-circuit of two lead wires can be avoided.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 is a perspective view of this invention;

FIG. 2 is an exploded partial view in three dimensions of this invention;

FIG. 3 is an enlarged partial view of the damper of this invention; and

FIG. 4 is a cutaway sectional view of the damper of this invention.

### DETAILED DESCRIPTION OF THE INVENTION

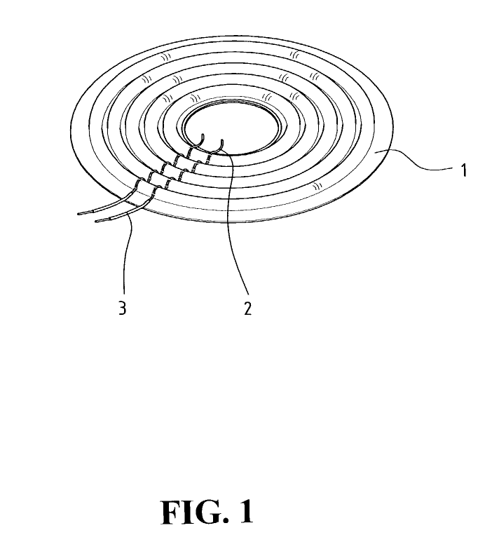

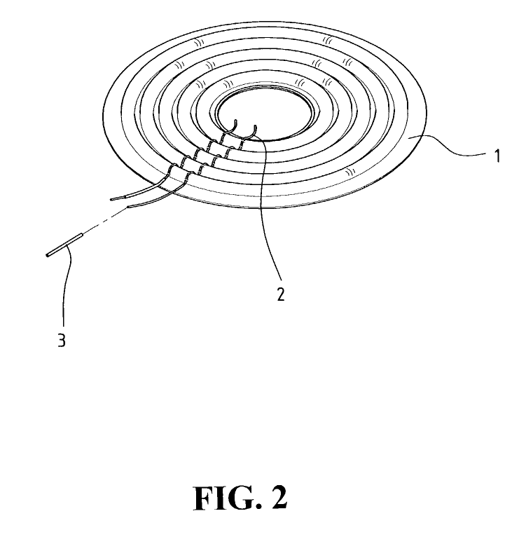

With reference to a perspective view (FIG. 1) and an exploded partial view (FIG. 2) enclosed, a speaker's damper with lead wire and guide sleeve of this invention shown in these figures is comprised of a main body 1 and a plurality of lead wires 2 and guide sleeves 3.

The damper's main body 1 is essentially a piece of woven cloth pressed in form of an annular disk with a corrugated cutaway section. The lead wire 2 is a metallic wire in texture properly interwoven in the damper's main body 1, such that the so-called jumping-rope phenomenon can be avoided when the damper's main body 1 is in vibration. Moreover, the portion of lead wire 2 that projects out of the damper's main body 1 is sheathed with a guide sleeve made of an insulation material in a tubular configuration. By means of the guide sleeve 3, the projected portion of the lead wires 2 out of the damper's main body 1 can be hence prevented from being short-circuited or ruptured by vibration.

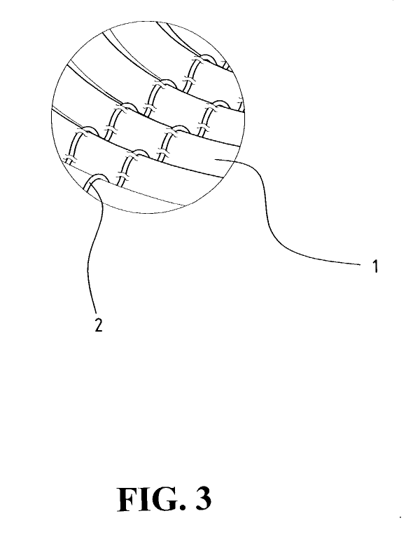

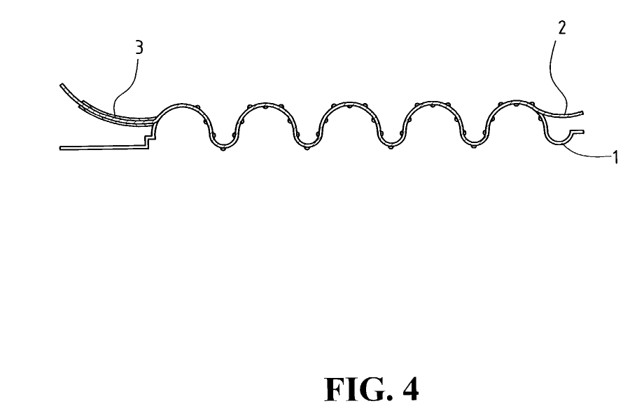

An enlarged partial view and a cutaway sectional view of the damper of this invention are shown in FIG. 3 and FIG. 4. As indicated in FIGS. 3 and 4, there is a damper's main body 1 of woven cloth configured in form of an annular disk with a corrugated cutaway section, in which a lead wire 2, substantially a metallic wire in texture, which is in charge of introducing an external signal to a speaker's voice coil, is properly interwoven in the damper's main body 1 so that the jumping-rope phenomenon of the lead wire 2 and accordingly the rupture thereof can be prevented every time when the damper's main body 1 is caused to vibrate.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A speaker's damper with lead wire and guide sleeve, comprising:
a damper's main body, which is essentially a piece of woven cloth pressed in form of an annular disk with a corrugated cutaway section, in which lead wire is properly interwoven during the process of pressing the damper's main body;
a lead wire being interwoven in said damper's main body when the main body is put under a molding process; and said lead wire having two ends projected out of said damper's main body; and
a guide sleeve made of an insulation material being sleeved on the outside portion of the lead wire projected out of said damper's main body.
